(19) United States
(12) Patent Application Publication
(10) Pub. No.: US 2025/0376323 A1
(43) Pub. Date: Dec. 11, 2025

(54) FOOT-OPERATED FLIP-TOP TRASH CAN

(71) Applicant: TEST RITE INTERNATIONAL CO., LTD, Taipei (TW)

(72) Inventor: Ching Yueh, Taipei (TW)

(21) Appl. No.: 18/822,464

(22) Filed: Sep. 2, 2024

(30) Foreign Application Priority Data
Jun. 5, 2024 (CN) 202421277035.5

(51) Int. Cl. B65F 1/16; B65F 1/06

(52) U.S. Cl. CPC B65F 1/163; B65F 1/062; B65F 2210/129

(57) ABSTRACT

A foot-operated flip-top trash can includes a receiving assembly comprising a can body having a receiving cavity and an exposure opening formed at a top end of the can body and communicated with the receiving cavity; a covering-closing mechanism comprising a covering-closing assembly and at least one connector; and a trigger mechanism comprising a pedal and at least one top-pusher, wherein the pedal is rotatably mounted on a low end of the can body, one end of the pedal is rotatably connected with the top-pusher, one end of the top-pusher away from the pedal is clamped to the clamping channel, and the top-pusher is driven by the pedal to move upward in case where the pedal is stepped on to be rotated.

### CROSS REFERENCE OF RELATED APPLICATION

This application claims priority to Chinese Patent Application No. CN 202421277035.5, filed on Jun. 5, 2024, the content of which is incorporated herein by reference in its entirety.

### TECHNICAL FIELD

The present disclosure relates to the technical field of trash cans, and more particularly to a foot-operated flip-top trash can.

### BACKGROUND

At present, most trash cans are provided with a cover to cover the opening of the can body, so as to prevent the strange smell of the trash inside the can body from going everywhere. In addition, in order to be conducive to opening, some trash cans are opened with a foot-operated pedal. After this kind of trash can is opened, it is usually to be closed under the gravity of the cover itself, which results in the opening angle of the cover being kept within 90°, otherwise, it will not be able to close automatically.

During using the trash can, the cover blocks parts of the opening and forms a clamping opening with the top end of the can body. After the trash is put into the clamping opening, it passes through the opening and finally falls into the can body. Since the clamp opening is faced towards the horizontal direction, in order to ensure that the trash can be aligned with the clamp opening, most users need to bend down to put it in, and the cover with an opening angle limited to within 90° can block the trash to be put in and increase the difficulty of trash to be put in.

In addition, when the trash is continuously put, the user needs to keep his/her foot on the pedal, which limits the movement range of the user. Once the position of the trash exceeds the movement range of the user, the user needs to release the pedal and later to operate again the pedal to open, which is very inconvenient to use.

In addition, the upper end of some trash cans is provided with a rotatable collar ring. By rotating the collar ring to the opening to press on the top end of the can body, the edge part of the trash bag in the can body overlaps with the top end of the can body and is clamped, so as to realize the fixation of the trash bag to prevent the trash bag from sliding down due to the gravity of the internal trash and affecting putting the trash in. Since the rotation angle of the cover is limited to within 90°, the rotation angle of the collar is limited, resulting in the opening not being completely opened, making it difficult to take out the trash bag containing trash from the can body, and it is not convenient to replace the trash bag.

### SUMMARY

In order to solve the above technical problems and achieve at least one advantage of the present disclosure, the present disclosure provides a foot-operated flip-top trash can comprising:
a receiving assembly comprising a can body having a receiving cavity and an exposure opening formed at a top end of the can body and communicated with the receiving cavity, where a trash bag is placed in the receiving cavity in a stretched manner and an edge portion of the trash bag being extended from the exposure opening to overlap a top portion of the can body;

a covering-closing mechanism comprising a covering-closing assembly and at least one connector, where the covering-closing assembly comprises a main cover and an auxiliary cover, the connector is rotatably mounted on the receiving assembly, the main cover is mounted on the connector to be rotated together with the connector, the auxiliary cover is inserted and matched with the connector to rotate relative to the main cover in a coaxial manner with the connector, the covering-closing assembly is rotated with the connector together to open or close the exposure opening, the auxiliary cover has a circular opening, a size of the circular opening is smaller than a size of the main cover, the main cover is rotated relative to the auxiliary cover to open or close the circular opening, in a case where the covering-closing mechanism seals the exposure opening, the auxiliary cover is corresponding to an opening edge of the exposure opening and clamps the edge portion of the trash bag with an upper portion of the can body, the main cover is disposed on a top surface of the auxiliary cover to seal the circular opening, the auxiliary cover is pushed to drive the main cover to leave the exposure opening together, a maximum rotation angle of the auxiliary cover is consistent with a maximum rotation angle of the main cover, the connector has a clamping channel, the clamping channel comprises a pushed portion and a locking portion communicated with the pushed portion, the locking portion is formed by extending a bottom end of the pushed portion and forming an included angle of not less than 90° with the pushed portion; and
a trigger mechanism comprising a pedal and at least one top-pusher, wherein the pedal is rotatably mounted on a low end of the can body, one end of the pedal is rotatably connected with the top-pusher, one end of the top-pusher away from the pedal is clamped to the clamping channel, and the top-pusher is driven by the pedal to move upward in a case where the pedal is stepped on to be rotated, by pushing an inner wall of the pushed portion to drive the main cover to rotate away from the circular opening of the auxiliary cover covering the opening edge of the exposure opening, in a case where the top-pusher is clamped to the pushed portion and the pedal is not applied with external force, the main cover rotates towards the circular opening under gravity to seal the exposure opening by closing the circular opening. after the circular opening of the auxiliary cover covering the opening edge of the exposure opening is opened by stepping on the pedal, the main cover is pushed to continue to rotate away from the circular opening and locked at a position where the rotation angle is not less than 90° by the top-pusher being clamped with the locking portion.

According to an embodiment of the present disclosure, a bottom portion of the can body is formed with a mounting groove and a through opening communicated with the mounting groove, the pedal is rotatably mounted in the mounting groove, an end portion of the pedal away from the top-pusher is extended from a side portion of the can body to outside through the through opening, in a case where the can body is supported on the ground, the end portion of the pedal extended from the through opening is spaced from the ground by a predetermined distance, and an end portion of the pedal connected with the top-pusher is spaced from a top wall of the mounting groove by a predetermined distance.

According to an embodiment of the present disclosure, a circular groove is formed on a side of the auxiliary cover away from the main cover, the circular groove is located on an outer periphery of the circular opening, in a case where the auxiliary cover covers the opening edge of the exposure opening, the upper end of the can body is inserted into the circular groove to clamp the edge portion of the trash bag, in a case where the edge portion of the trash bag overlaps the top portion of the can body and hangs down on an outer peripheral wall of the can body, the auxiliary cover is sleeved on the upper end of the can body, so that the edge portion of the trash bag hanging from the outer peripheral wall of the can body is hidden in the circular groove.

According to an embodiment of the present disclosure, the receiving assembly further comprises a bag-storage body, the bag-storage body is mounted in the can body, the bag-storage body has a bag-storage cavity and an access opening communicated with the bag-storage cavity, the bag-storage cavity is for storing unused trash bags, and the access opening is for taking unused trash bags in the bag-storage cavity or placing unused trash bags into the bag-storage cavity.

According to an embodiment of the present disclosure, the access opening is formed at the top end of the bag-storage body and adjacent to the exposure opening, and in a case where the auxiliary cover covers the opening edge of the exposure opening, the access opening is covered by the auxiliary cover.

According to an embodiment of the present disclosure, the foot-operated flip-top trash can further comprises a buffer mechanism, the buffer mechanism comprises at least one first buffer assembly, the first buffer assembly is mounted on the receiving assembly, and a top end of the first buffer assembly is corresponding to the main cover or the connector, the first buffer assembly is retractable, and in a case where the covering-closing assembly seals the exposure opening, the first buffer assembly is squeezed by the main cover or the connector to be compressed, and during the main cover is rotating away from the exposure opening, the first buffer assembly is gradually stretched, and in a case where the top-pusher is clamped to the pushed portion and pedaling force applied to the pedal disappears, the main cover and the connector gradually rotates towards the exposure opening and presses on the first buffer assembly to be slow movements thereof.

According to an embodiment of the present disclosure, the buffer mechanism further comprises at least one second buffer assembly, the second buffer assembly is mounted in the receiving assembly, and a top end of the second buffer assembly is corresponding to the auxiliary cover, and the second buffer assembly is retractable, in a case where the auxiliary cover covers the opening edge of the exposure opening, the second buffer assembly is squeezed to be compressed by the auxiliary cover, and during the auxiliary cover rotates away from the exposure opening, the second buffer assembly is gradually stretched, and in a case where the rotation angle of the auxiliary cover is consistent with the rotation angle of the main cover driven by the trigger mechanism, the auxiliary cover gradually rotates towards the exposure opening to press on the second buffer assembly under the gravity to slow movements thereof.

According to an embodiment of the present disclosure, the foot-operated flip-top trash can further comprises a deodorizing box, the deodorizing box comprises a box member, the box member is mounted on the main cover and rotates together with the main cover, the box member has a placement space and a plurality of ventilation holes communicated with the placement space, the placement space is for placing a filter, and in a case where the covering-closing assembly seals the exposure opening, the box member is placed in the receiving cavity.

According to an embodiment of the present disclosure, the box member comprises a box body and a cover body, the box body is mounted on the main cover, any one of the box body and the cover body form a ventilation hole, the placement space is formed in the box body, and the box body further has a placement opening communicated with the placement space, a size of the placement opening is adapted to a size of the cover body, the placement opening is for taking out the filter inside the placement space or placing the filter into the placement space, and the cover body is mounted on the box body so as to open or close the placement opening.

According to an embodiment of the present disclosure, the deodorizing box further comprises a start-end date display member comprising a date identifier rotatably mounted on the box member, twelve month-identifiers are arranged and equally spaced on a surface of date identifier with an axis of the date identifier being a center thereof, and a start-end date display assembly comprising a start-date display structure and an end-date display structure both provided on the box member, the date identifier is rotatable, so that any one of the month-identifiers on the surface is corresponding to the start-date display structure or the end-date display structure, and in a case where one of the month-identifier on the date identifier is corresponding to the start-date display structure, another one of the month-identifier spaced with a predetermined distance with the month-identifier is corresponding to the end-date display structure, the number of months between the months represented by the two month-identifiers is consistent with an expiration period of the filter.

### BRIEF DESCRIPTION OF THE DRAWINGS

FIG. 1 is a schematic structural diagram of a foot-operated flip-top trash can of the present disclosure.

FIG. 2 is a cross-sectional view of the structure of FIG. 1.

FIG. 3 is a structural perspective view of the can body of the foot-operated flip-top trash can of the present disclosure.

FIG. 4 is a schematic structural diagram of the foot-operated flip-top trash can of the present disclosure in one state.

FIG. 5 is an enlarged view of the partial structure of FIG. 4.

FIG. 6 is an enlarged view of the partial structure of FIG. 4.

FIG. 7 is a schematic structural diagram of the foot-operated flip-top trash can of the present disclosure in another state.

FIG. 8 is an enlarged view of the partial structure of FIG. 7.

FIG. 9 is a schematic structural diagram of the foot-operated flip-top trash can of the present disclosure in yet another state.

FIG. 10 is an enlarged view of the partial structure of FIG. 9.

FIG. 11 is an enlarged view of the structure of FIG. 9.

FIG. 12 is a structural exploded view of the deodorizing box of the foot-operated flip-top trash can of the present disclosure.

### DETAILED DESCRIPTION OF THE EMBODIMENTS

The following description serves to disclose the present disclosure to enable those skilled in the art to implement the present disclosure. The embodiments in the following description are given by way of example only, and other modifications will be apparent to those skilled in the art. The basic principles of the present disclosure defined in the following description can be applied to other embodiments, modifications, improvements, equivalents, and other technical solutions that do not depart from the spirit and scope of the present disclosure.

One skilled in the art should understand that in the disclosure of the present disclosure, the orientation or positional relationship indicated by the terms “longitudinal”, “lateral”, “upper”, “lower”, “front”, “back”, “left”, “right”, “vertical”, “horizontal”, “top”, “bottom”, “inner”, “outer”, etc. are based on the orientation or positional relationship shown in the drawings, and is merely intended to facilitate and simplify the description of the present disclosure, and does not indicate or imply that the referred device or element must have a specific orientation, be constructed and operate in a specific orientation, and therefore the above terms cannot be understood as a limitation of the present disclosure.

It is to be understood that the term “a/an” should be understood as “at least one” or “one or more”, i.e., in one embodiment, the number of elements may be one, while in further embodiments, the number of elements may be multiple, and the term “a/an” should not be understood as a limitation of the number.

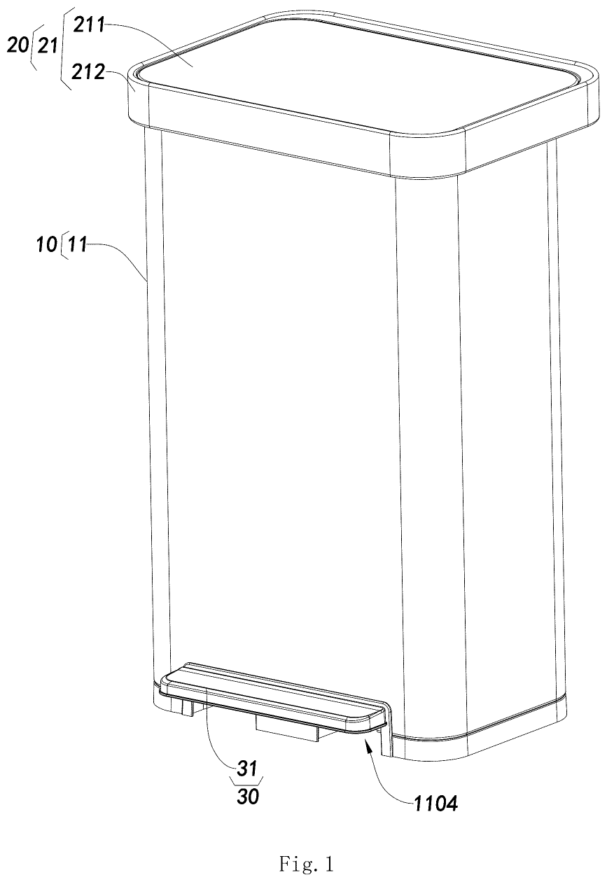

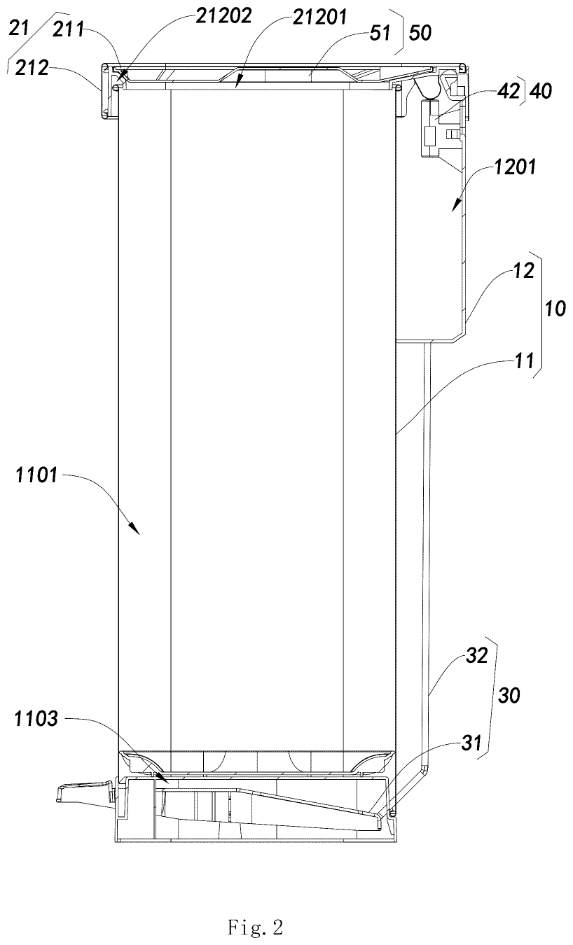

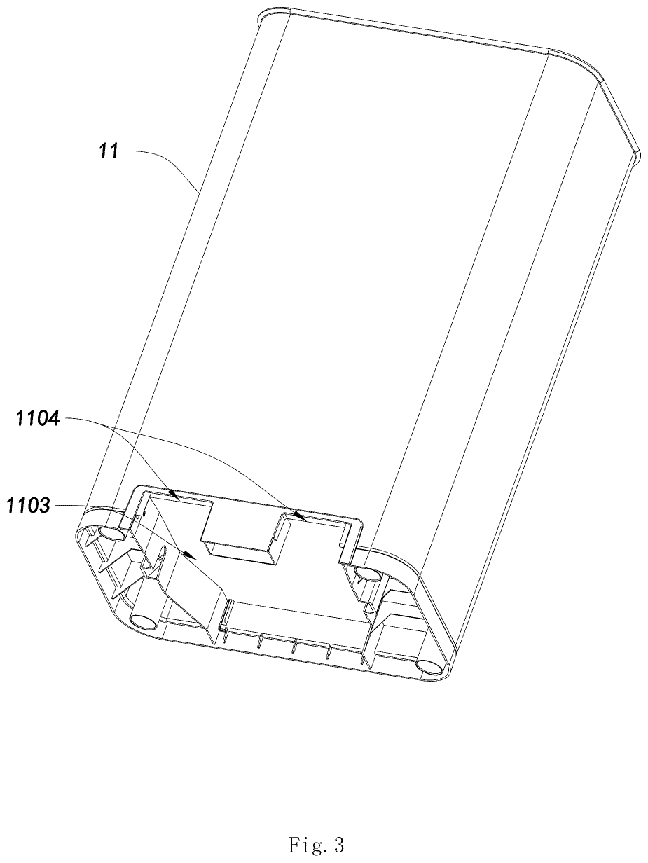

With reference to FIGS. 1 to 4, a foot-operated flip-top trash can according to one embodiment of the present disclosure will be described in detail below. The foot-operated flip-top trash can comprises a receiving assembly 10 comprising a can body 11 having a receiving cavity 1101 and an exposure opening 1102 formed at a top end of the can body 11 and communicated with the receiving cavity 1101. The trash bag is placed in the receiving chamber 1101 in a stretched manner, and the edge portion thereof is extended from the exposure opening 1102 to overlap the top portion of the can body 11.

The foot-operated flip-top trash can comprises a covering-closing mechanism 20 comprising a covering-closing assembly 21 and at least one connector 22, the covering-closing assembly 21 comprises a main cover 211 and an auxiliary cover 212, the connector 22 is rotatably mounted to the receiving assembly 10, the main cover 211 is mounted to the connector 22 and rotatable together with the connector 22, the auxiliary cover 212 is inserted and matched with the connector 22 and rotatable relative to the main cover 211 in a coaxial manner with the connector 22, and the covering-closing assembly 21 is rotatable with the connector 22 together to open or close the exposure opening 1102. The auxiliary cover 212 has a circular opening 21201 having a size smaller than the size of the main cover 211, and the main cover 211 is rotatable relative to the auxiliary cover 212 to open or close the circular opening 21201. In a case where the covering-closing assembly 21 seals the exposure opening 1102, the auxiliary cover 212 is corresponding to the opening edge of the exposure opening 1102 and is clamped on the edge portion of the trash bag with the upper end of the can body 11 to fix the trash bag, and the main cover 211 is placed on the upper surface of the auxiliary cover 212 to seal the circular opening 21201 to seal the exposure opening 1102 by sealing the circular opening 21201. The auxiliary cover 212 can be pushed to drive the main cover 211 to rotate away from the exposure opening 1102 together, and the maximum rotation angle of the auxiliary cover 212 is consistent with the maximum rotation angle of the main cover 211.

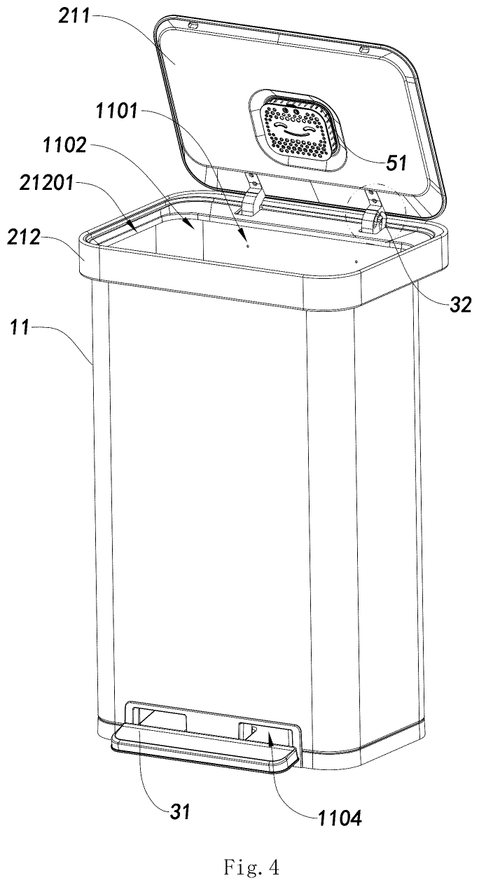

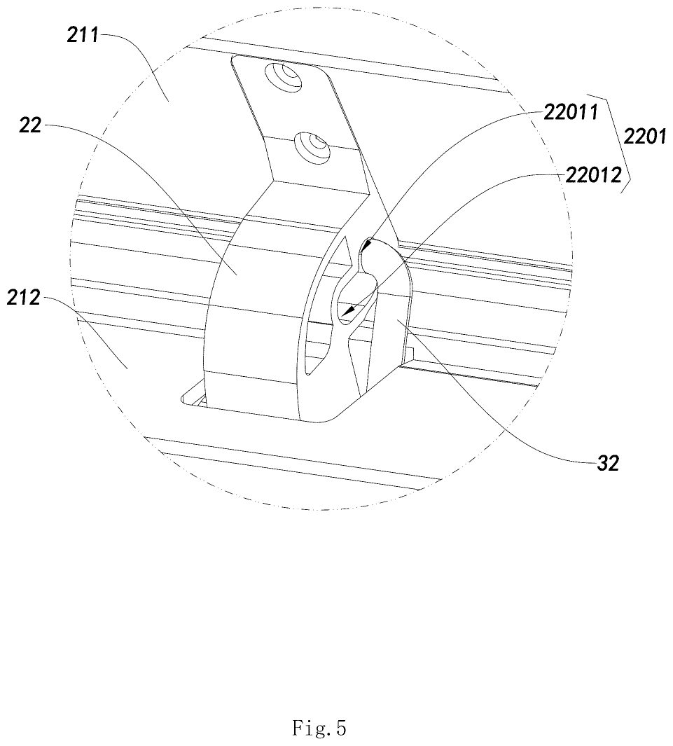

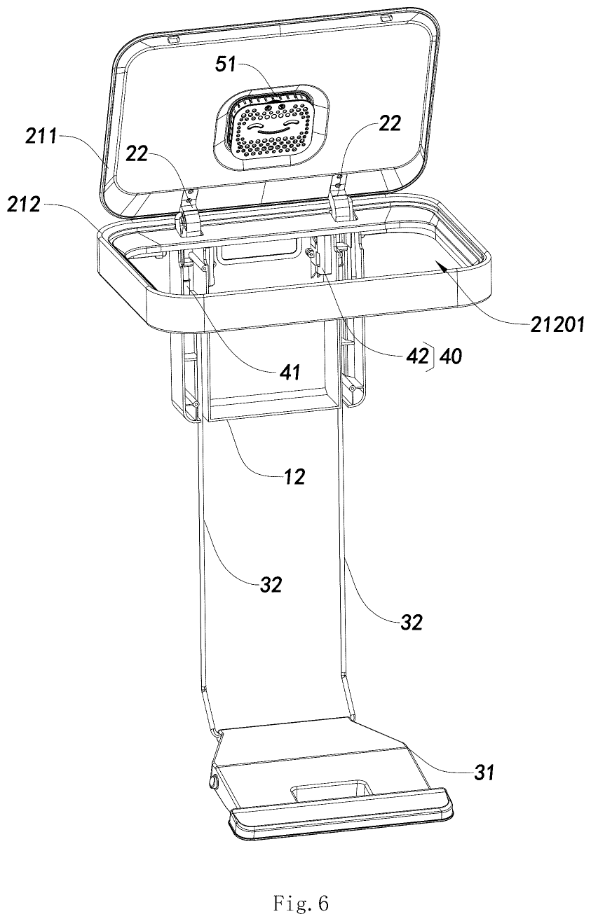

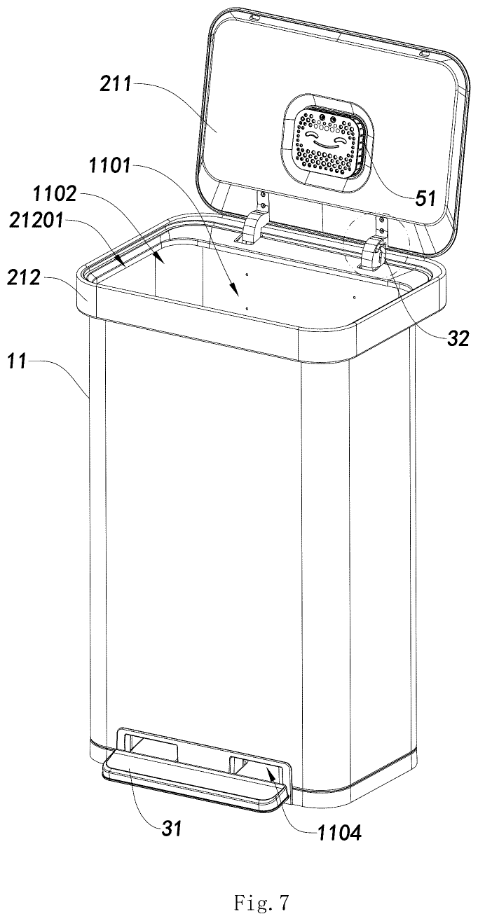

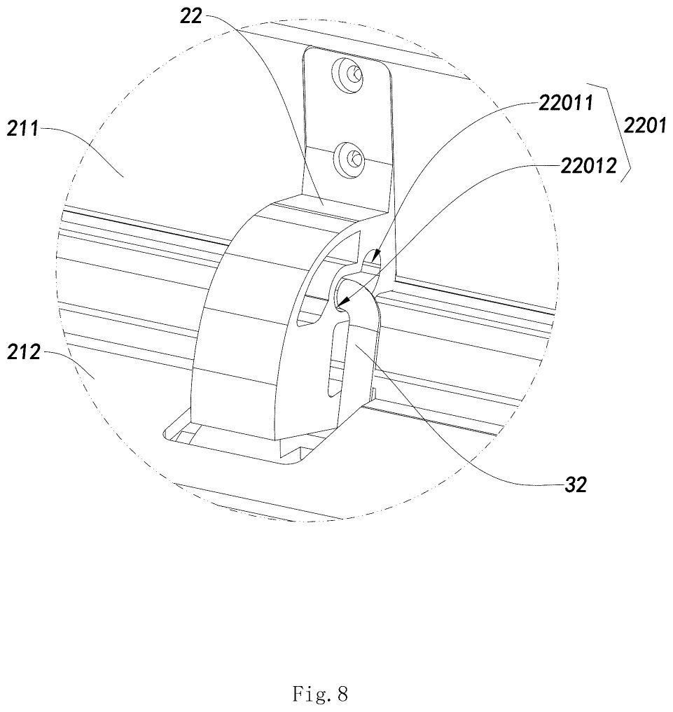

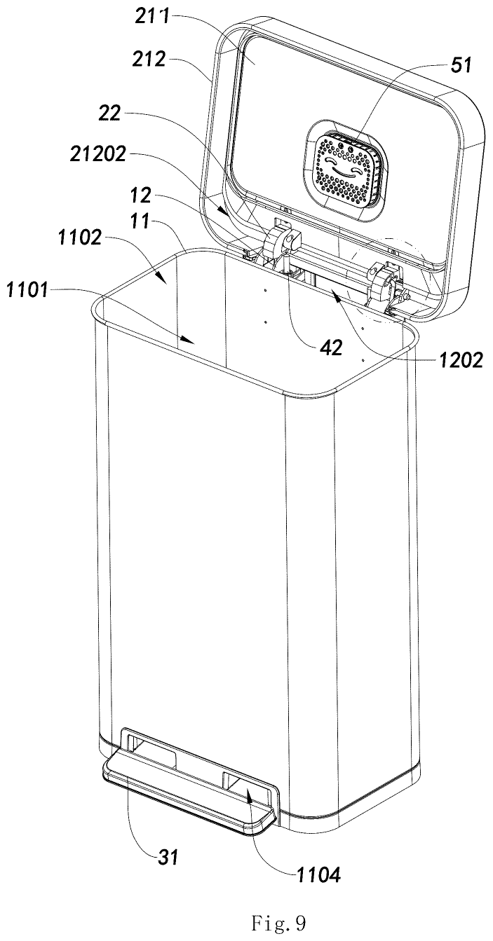

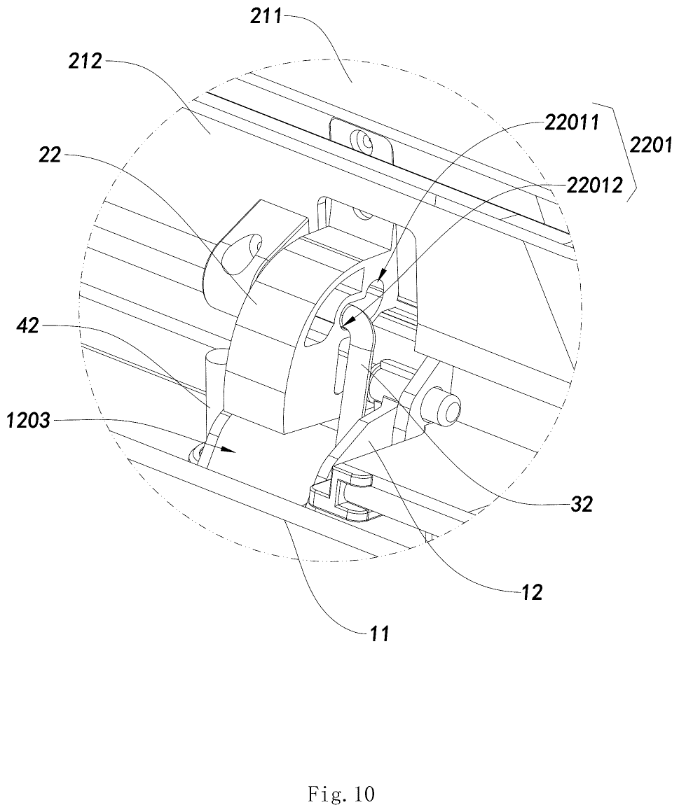

With reference to FIGS. 4 to 11, the foot-operated flip-top trash can further comprises a trigger mechanism 30 comprising a pedal 31 rotatably mounted on a low end of the can body 11 and at least one top-pusher 32 rotatably connected to one end of the pedal 31.

The connector 22 has a clamping channel 2201, an end portion of the top-pusher 32 away from the pedal 31 is clamped with the clamping channel 2201. The clamping channel 2201 comprises a pushed portion 22011 and a locking portion 22012 communicated with the pushed portion 22011, the locking portion 22012 being formed by extending a bottom end of the pushed portion 22011 and forming an included angle of not less than 90° with the pushed portion 22011. In a case where the top-pusher 32 is driven upward with the pedal 31 being stepped on and rotated, and the inner wall of the pushed portion 22011 is top-pushed to drive the main cover 211 away from the circular opening 21201 of the auxiliary cover 212 covering the opening edge of the exposure opening 1102. In a case where the top-pusher 32 is clamped with the pushed portion 22011 and the pedal 31 is not applied with an external force, the main cover 211 can rotate to the circular opening 21201 under the action of its own gravity to seal the exposure opening 1102 by closing the circular opening 21201. After the circular opening 21201 of the auxiliary cover 212 covering the opening edge of the exposure opening 1102 is opened by stepping on the pedal 31 with the foot, the main cover 211 can be pushed to continue to rotate away from the circular opening 21201 and be locked at a position where the rotation angle is not less than 90° by the top-pusher 32 being clamped with the locking portion 22012.

In this way, through the design of the auxiliary cover 212, the trash bag in the receiving cavity 1101 can be effectively fixed to prevent the trash bag from slipping down and conducive to putting the trash. In addition, the main cover 211 can be rotated twice successively and finally locked at a position with an angle of not less than 90°, so that the circular opening 21201 of the auxiliary cover 212 covering the opening edge of the exposure opening 1102 is completely opened, effectively avoiding the situation that the trash is not easily disposed due to the incomplete opening of the circular opening 21201, and during the trash disposed process, there is no need to step on the pedal 31 throughout the entire process, thereby increasing the convenience of trash disposed. In addition, since both the main cover 211 and the auxiliary cover 212 can be rotated to a position at an angle of not less than 90°, the exposure opening 1102 can be completely opened to replace the trash bag.

Optionally, two connectors 22 are provided and the two connectors 22 are spaced apart by a predetermined distance, the two connectors 22 are rotatably mounted to the receiving assembly 10 in such a manner that the ends of the two connectors 22 close to each other are inserted into the receiving assembly 10, and the other ends of the two connectors 22 away from each other are inserted into the auxiliary cover 212 and can be rotated relative to the auxiliary cover 212, and the connectors 22 are connected to the main cover 211 by at least one fastener. The number of top-pushers 32 is consistent with the number of connectors 22, and the two top-pushers 32 are respectively locked into the two clamping channels 2201 of the connectors 22. In this way, when the pedal 31 is pressed, the two top-pushers 32 are simultaneously driven by the pedal 31 to drive the main cover 211 away from the circular opening 21201 by top-pushing the connectors 22 respectively, thereby applying a uniform force to the main cover 211 and ensuring that the circular opening 21201 can be fully opened.

Optionally, a circular groove 21202 is formed on the side of the auxiliary cover 212 away from the main cover 211, and the circular groove 21202 is located on the outer periphery of the circular opening 21201. When the auxiliary cover 212 covers the opening edge of the exposure opening 1102, the upper end of the can body 11 is inserted into the circular groove 21202 to clamp the edge portion of the trash bag, thereby effectively fixing the trash bag, and effectively preventing the edge portion of the trash bag overlapping the top portion of the can body 11 from sliding into the receiving cavity 1101, thus preventing affecting putting the trash. In addition, in a case where the edge portion of the trash bag is overlapped with the top portion of the can body 11 and hangs down on the outer peripheral wall of the can body 11, the auxiliary cover 212 is sleeved with the upper end of the can body 11, so that the edge portion of the trash bag hanging from the outer peripheral wall of the can body 11 is hidden in the circular groove 21202, thereby improving the aesthetics during using.

Further, a mounting groove 1103 and a through opening 1104 communicated with the mounting groove 1103 are formed at the bottom of the can body 11. The pedal 31 is rotatably attached to the mounting groove 1103, and one end of the pedal 31 away from the pusher 32 is extended from the side portion of the can body 11 to the outside through the through opening 1104 for being stepped. In a case where the can body 11 is supported by the ground, one end of the pedal 31 extending from the through opening 1104 is spaced from the ground by a predetermined distance, and one end of the pedal 31 connected with the top-pusher 32 is spaced from the top wall of the mounting groove 1103 by a predetermined distance, so as to ensure that in a case where one end of the pedal 31 extending from the through opening 1104 is stepped on, the pedal 31 can be provided with sufficient rotation space to ensure the foot-operated flip-top trash can being normally used.

The receiving assembly 10 further comprises a bag-storage body 12, the bag-storage body 12 is mounted in the can body 11, the bag-storage body 12 has a bag-storage cavity 1201 and an access opening 1202 communicated with the bag-storage cavity 1201, the bag-storage cavity 1201 is for storing unused trash bags, the access opening 1202 is for taking unused trash bags in the bag-storage cavity 1201 or putting unused trash bags into the bag-storage cavity 1201.

It is worth mentioning that the access opening 1202 is formed at the top end of the bag-storage body 12 and adjacent to the exposure opening 1102. In a case where the auxiliary cover 212 covers the opening edge of the exposure opening 1102, the access opening 1202 is closed by the auxiliary cover 212 to prevent the strange smell from the trash put into the trash bag stretched in the receiving cavity 1101 from passing through the exposure opening 1102 and from the access opening 1202 to the bag-storage cavity 1201, and prevent resulting in pollution of the trash bag stored in the bag-storage cavity 1201. In addition, based on the position design of the access opening 1202, the taking-and-placing operation of the unused trash bags are all in the vertical direction, so that the bending range of the user can be as small as possible, and the convenience of operation is increased.

Optionally, the bag-storage body 12 and the portion of the pedal 31 extending from the through opening 1104 are disposed facing away, and the connector 22 is rotatably mounted on the top portion of the bag-storage body 12. In this way, the overall structure is compact and the aesthetic appearance is improved.

The foot-operated flip-top trash can also comprises a buffer mechanism 40, the buffer mechanism 40 comprises at least a first buffer assembly 41, the first buffer assembly 41 is mounted on the receiving assembly 10, and the top end of the first buffer assembly 41 is corresponding to the main cover 211 or the connector 22. The first buffer assembly 41 is provided to be retractable. In a case where the covering-closing assembly 21 seals the exposure opening 1102, the first buffer assembly 41 is pressed by the main cover 211 or the connector 22 to remain compressed. The first buffer assembly 41 gradually elongates while the main cover 211 rotates away from the exposure opening 1102. In a case where the top-pusher 32 is clamped with the pushed portion 22011 and the pedaling force applied to the pedal 31 disappears, the main cover 211 and the connector 22 as a whole can gradually rotate to the exposure opening 1102 under the action of their own gravity and press against the first buffer assembly 41 to slow down the movement of the main cover 211 and the connector 22 by the first buffer assembly 41.

Optionally, the first buffer assembly 41 is embodied as a damper.

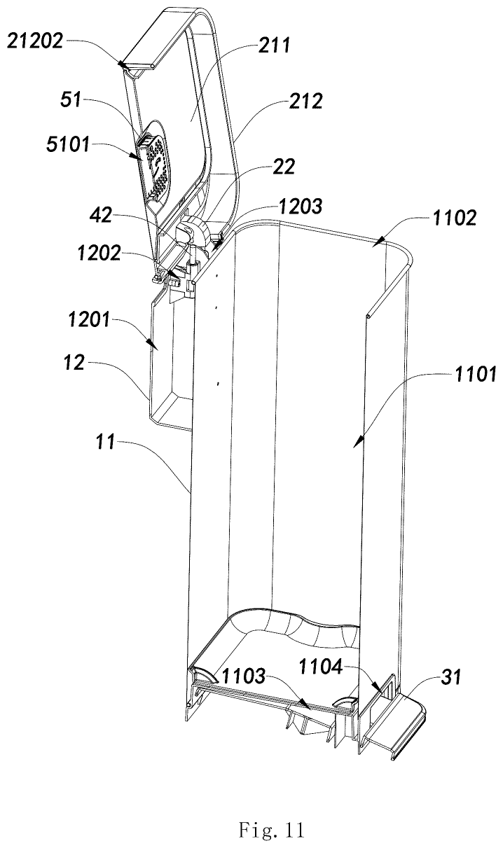

With reference to FIG. 11, optionally, one end of the first buffer assembly 41 away from the main cover 211 is mounted in the bag-storage body 12, and the bag-storage body 12 further forms at least one through hole 1203, and the first buffer assembly 41 is provided in the through hole 1203 to reduce the occupation of external space and increase the overall aesthetic appearance.

Optionally, the number of through holes 1203 is consistent with the number of first buffer assemblies 41 provided with two, and the two first buffer assemblies 41 are disposed with intervals, to fully buffer the main cover 211 during the main cover 211 is rotated to the exposure opening 1102.

Further, the buffer mechanism 40 further comprises at least one second buffer assembly 42, the second buffer assembly 42 is mounted on the receiving assembly 10, and the top end of the second buffer assembly 42 is corresponding to the auxiliary cover 212. The second buffer assembly 42 is provided to be retractable. In a case where the auxiliary cover 212 covers the opening edge of the exposure opening 1102, the second buffer assembly 42 is pressed and remains compressed by the auxiliary cover 212. The second buffer assembly 42 gradually elongates during the auxiliary cover 212 is rotated away from the exposure opening 1102. In a case where the rotation angle of the auxiliary cover 212 is consistent with the rotation angle of the main cover 211 driven by the trigger mechanism 30, the auxiliary cover 212 can gradually rotate to the exposure opening 1102 under the action of its own gravity and press against the second buffer assembly 42 to slow down the movement of the auxiliary cover 212 by the second buffer assembly 42.

Optionally, the second buffer assembly 42 is embodied as a damper.

Optionally, one end of the second buffer assembly 42 away from the auxiliary cover 212 is mounted in the bag-storage body 12, and the second buffer assembly 42 is disposed in the bag-storage cavity 1201 to reduce the occupation of external space and improve the overall aesthetic appearance.

Optionally, two second buffer assemblies 42 are provided, and the two second buffer assemblies 42 are spaced apart to fully buffer the auxiliary cover 212 during the auxiliary cover 212 rotates to the exposure opening 1102.

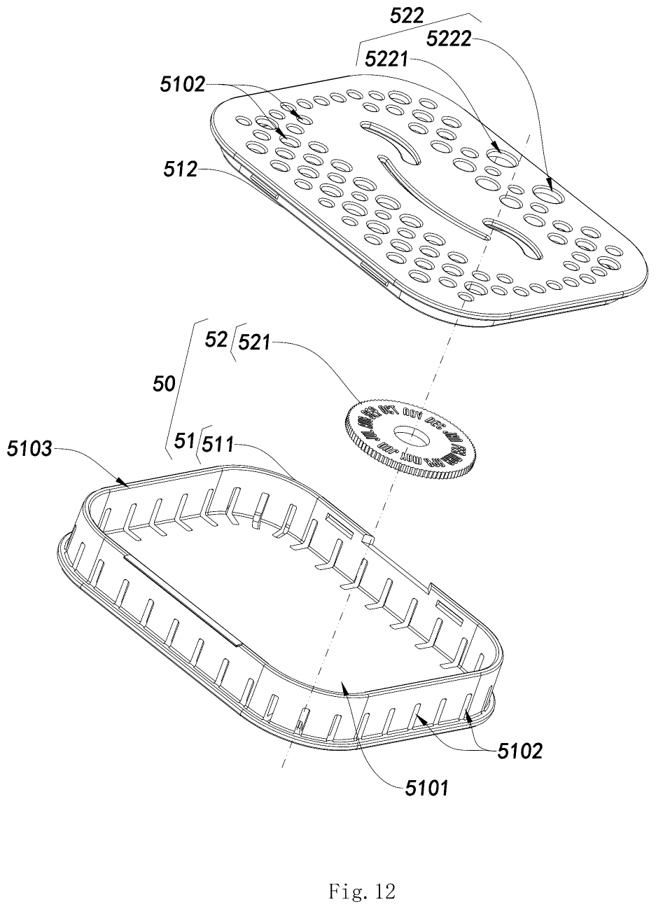

With reference to FIG. 12, the foot-operated flip-top trash can further comprises a deodorizing box 50 comprising a box member 51 mounted to the main cover 211 and rotatable together with the main cover 211. The box member 51 has a placement space 5101 and a plurality of ventilation holes 5102 communicated with the placement space 5101, and the placement space 5101 for placing a filter, such as activated carbon. In a case where the covering-closing assembly 21 seals the exposure opening 1102, the box member 51 is placed in the receiving cavity 1101, so that the filter mounted in the placement space 5101 can remove the strange smell from the trash in the trash bag.

Optionally, the box member 51 comprises a box body 511 and a cover body 512, the box body is mounted on the main cover 211, and any one of the box body 511 and the cover body 512 form a ventilation hole 5102. The placement space 5101 is formed in the box body 511, and the box body 511 further has a placement opening 5103 communicated with the placement space 5101, the size of the placement opening 5103 is matched with the size of the cover body 512, and the placement opening 5103 is for taking the filter in the placement space 5101 or putting the filter into the placement space 5101. The cover body 512 is mounted on the box body 511 so as to be able to open or close the placement opening 5103 so as to replace the filter.

In one embodiment, the box member 51 further has a placement opening 5103 communicated with the placement space 5101, the placement opening 5103 is formed on a side wall of the box member 51 away from the rotation axis of the main cover 211 or a side wall of the box member 51 located in the radial direction of the rotation shaft of the main cover 211, and the placement opening 5103 is for the filter to be withdrawn or inserted into the placement space 5101 so as to replace the filter by drawing and inserting the filter.

In another embodiment, the box member 51 is detachably mounted to the main cover 211, and the filter is replaced by detaching the box member 51.

Further, the deodorizing box 50 further comprises a start-end date display member 52 comprising a date identifier 521 rotatably mounted to the box member 51, and a start-end date display assembly 522, and twelve month-identifiers are arranged and equally spaced on a surface of date identifier 521 with an axis of the date identifier 521 being a center of the month-identifiers. The start-end date display assembly 522 comprises a start-date display structure 5221 and an end-date display structure 5222, both of which are disposed on the box member 51. The date identifier 521 is rotatable, so that any one of the month-identifiers on the surface of the date identifier 521 is corresponding to the start date display structure 5221 or the end date display structure 5222. In a case where one month-identifier on the surface of the date mark 521 is corresponding to the start date display structure 5221, the other month-identifier separated by a predetermined distance from the corresponding month mark is corresponding to the end date display structure 5222, and the number of months between the months represented by the two month-identifiers is consistent with the validity period of the filter, so as to prompt the user to replace the filter in time.

Optionally, the date identifier 521 is rotatably attached to the placement space 5101 and partially protrudes from the placement space 5101, and the portion of the date identifier 521 protruding from the placement space 5101 can be applied with force so as to rotate the entire portion. Both the start date display structure 5221 and the end date display structure 5222 are embodied as observation holes formed in one side wall of the box member 51 away from the main cover 211. In a case where the main cover 211 is rotated away from the exposure opening 1102, the user can see the month-identifier corresponding to the corresponding observation hole on the surface of the date identifier 521 through the observation hole, so as to know the replacement month of the filter.

Alternatively, the date identifier 521 is rotatably mounted on a side wall of the box member 51 away from the main cover 211, and both the start date display structure 5221 and the end date display structure 5222 are embodied as indicating fingers provided on the side wall of the box member 51 away from the main cover 211. In a case where the main cover 211 is rotated away from the exposure opening 1102, the user can see the specific one month pointed by the indicating finger on the surface of the date identifier 521, thereby knowing the month of replacement of the filter.

It should be understood by those skilled in the art that the embodiments of the present disclosure shown in the above description and the accompanying drawings are by way of example only and do not limit the present disclosure. The advantages of the present disclosure have been completely and effectively realized. The functional and structural principles of the present disclosure have been shown and described in the embodiments, and the embodiments of the present disclosure may be modified or modified in any way without departing from the principles.

What is claimed is:

1. A foot-operated flip-top trash can, comprising:
a receiving assembly comprising a can body having a receiving cavity and an exposure opening formed at a top end of the can body and communicated with the receiving cavity, wherein a trash bag is placed in the receiving cavity in a stretched manner and an edge portion of the trash bag being extended from the exposure opening to overlap a top portion of the can body;
a covering-closing mechanism comprising a covering-closing assembly and at least one connector, wherein the covering-closing assembly comprises a main cover and an auxiliary cover, the connector is rotatably mounted on the receiving assembly, the main cover is mounted on the connector to be rotated together with the connector, the auxiliary cover is inserted and matched with the connector to rotate relative to the main cover in a coaxial manner with the connector, the covering-closing assembly is rotated with the connector together to open or close the exposure opening, the auxiliary cover has a circular opening, a size of the circular opening is smaller than a size of the main cover, the main cover is rotated relative to the auxiliary cover to open or close the circular opening, in case where the covering-closing mechanism seals the exposure opening, the auxiliary cover is corresponding to an opening edge of the exposure opening, so as to clamp an edge portion of a trash bag with an upper portion of the can body, the main cover is disposed on a top surface of the auxiliary cover to seal the circular opening, the auxiliary cover is pushed to drive the main cover to leave the exposure opening together, a maximum rotation angle of the auxiliary cover is consistent with a maximum rotation angle of the main cover, the connector has a clamping channel, the clamping channel comprises a pushed portion and a locking portion communicated with the pushed portion, the locking portion is formed by extending a bottom end of the pushed portion and forming an included angle of not less than 90° with the pushed portion; and
a trigger mechanism comprising a pedal and at least one top-pusher, wherein the pedal is rotatably mounted on a low end of the can body, one end of the pedal is rotatably connected with the top-pusher, one end of the top-pusher away from the pedal is clamped to the clamping channel, and the top-pusher is driven by the pedal to move upward in case where the pedal is stepped on to be rotated, by pushing an inner wall of the pushed portion to drive the main cover to rotate away from the circular opening of the auxiliary cover covering the opening edge of the exposure opening, in case where the top-pusher is clamped to the pushed portion and the pedal is not applied with external force, the main cover rotates towards the circular opening under gravity to seal the exposure opening by closing the circular opening, after the circular opening of the auxiliary cover covering the opening edge of the exposure opening is opened by stepping on the pedal, the main cover is pushed to continue to rotate away from the circular opening and locked at a position where a rotation angle is not less than 90° by the top-pusher being clamped with the locking portion.

2. The foot-operated flip-top trash can according to claim 1, wherein a bottom portion of the can body is formed with a mounting groove and a through opening communicated with the mounting groove, the pedal is rotatably mounted in the mounting groove, an end portion of the pedal away from the top-pusher is extended from a side portion of the can body to outside through the through opening, in case where the can body is supported on the ground, the end portion of the pedal extended from the through opening is spaced from the ground by a predetermined distance, and an end portion of the pedal connected with the top-pusher is spaced from a top wall of the mounting groove by a predetermined distance.

3. The foot-operated flip-top trash can according to claim 1, wherein a circular groove is formed on a side of the auxiliary cover away from the main cover, the circular groove is located on an outer periphery of the circular opening, in case where the auxiliary cover covers the opening edge of the exposure opening, the upper end of the can body is inserted into the circular groove to clamp the edge portion of the trash bag, in case where the edge portion of the trash bag overlaps the top portion of the can body and hangs down on an outer peripheral wall of the can body, the auxiliary cover is sleeved on the upper end of the can body, so that the edge portion of the trash bag hanging from the outer peripheral wall of the can body is hidden in the circular groove.

4. The foot-operated flip-top trash can according to claim 1, wherein the receiving assembly further comprises a bag-storage body, the bag-storage body is mounted in the can body, the bag-storage body has a bag-storage cavity and an access opening communicated with the bag-storage cavity, the bag-storage cavity is for storing unused trash bags, and the access opening is for taking unused trash bags in the bag-storage cavity.

5. The foot-operated flip-top trash can according to claim 4, wherein the access opening is formed at the top end of the bag-storage body and adjacent to the exposure opening, and when the auxiliary cover covers the edge of the exposure opening, the access opening is covered by the auxiliary cover.

6. The foot-operated flip-top trash can according to claim 1, wherein the foot-operated flip-top trash can further comprises a buffer mechanism, the buffer mechanism comprises at least one first buffer assembly, the first buffer assembly is mounted on the receiving assembly, and a top end of the first buffer assembly is corresponding to the main cover, the first buffer assembly is retractable, and in case where the covering-closing assembly seals the exposure opening, the first buffer assembly is squeezed by the main cover to be compressed, and during the main cover is rotating away from the exposure opening, the first buffer assembly is gradually stretched, and in case where the top-pusher is clamped to the pushed portion and pedaling force applied to the pedal disappears, the main cover and the connector gradually rotates towards the exposure opening and presses on the first buffer assembly to be slow movements thereof.

7. The foot-operated flip-top trash can according to claim 6, wherein the buffer mechanism further comprises at least one second buffer assembly, the second buffer assembly is mounted in the receiving assembly, and a top end of the second buffer assembly is corresponding to the auxiliary cover, and the second buffer assembly is retractable, in case where the auxiliary cover covers the opening edge of the exposure opening, the second buffer assembly is squeezed to be compressed by the auxiliary cover, and during the auxiliary cover rotates away from the exposure opening, the second buffer assembly is gradually stretched, and in case where the rotation angle of the auxiliary cover is consistent with the rotation angle of the main cover driven by the trigger mechanism, the auxiliary cover gradually rotates towards the exposure opening to press on the second buffer assembly under the gravity to slow movements thereof.

8. The foot-operated flip-top trash can according to claim 1, wherein the foot-operated flip-top trash can further comprises a deodorizing box, the deodorizing box comprises a box member, the box member is mounted on the main cover and rotate together with the main cover, the box member has a placement space and a plurality of ventilation holes communicated with the placement space, the placement space is for placing a filter, and in case where the covering-closing assembly seals the exposure opening, the box member is placed in the receiving cavity.

9. The foot-operated flip-top trash can according to claim 8, wherein the box member comprises a box body and a cover body, the box body is mounted on the main cover, any one of the box body and the cover body form a ventilation hole, the placement space is formed in the box body, and the box body further has a placement opening communicated with the placement space, a size of the placement opening is adapted to a size of the cover body, the placement opening is for taking out the filter inside the placement space, and the cover body is mounted on the box body so as to open or close the placement opening.

10. The foot-operated flip-top trash can according to claim 9, wherein the deodorizing box further comprises a start-end date display member comprising a date identifier rotatably mounted on the box member, twelve month-identifiers are arranged and equally spaced on a surface of date identifier with an axis of the date identifier being a center thereof, and a start-end date display assembly comprising a start-date display structure and an end-date display structure both provided on the box member, the date identifier is rotatable, so that any one of the month-identifiers on the surface is corresponding to the start-date display structure, and in case where one of the month-identifier on the date identifier is corresponding to the start-date display structure, another one of the month-identifier spaced with a predetermined distance with the month-identifier is corresponding to the end-date display structure, the number of months between the months represented by the two month-identifiers is consistent with an expiration period of the filter.

11. The foot-operated flip-top trash can according to claim 1, wherein the receiving assembly further comprises a bag-storage body, the bag-storage body is mounted in the can body, the bag-storage body has a bag-storage cavity and an access opening communicated with the bag-storage cavity, the bag-storage cavity is for storing unused trash bags, and the access opening is for placing unused trash bags into the bag-storage cavity.

12. The foot-operated flip-top trash can according to claim 1, wherein the foot-operated flip-top trash can further comprises a buffer mechanism, the buffer mechanism comprises at least one first buffer assembly, the first buffer assembly is mounted on the receiving assembly, and a top end of the first buffer assembly is corresponding to the connector, the first buffer assembly is retractable, and in case where the covering-closing assembly seals the exposure opening, the first buffer assembly is squeezed by the connector to be compressed, and during the main cover is rotating away from the exposure opening, the first buffer assembly is gradually stretched, and in case where the top-pusher is clamped to the pushed portion and pedaling force applied to the pedal disappears, the main cover and the connector gradually rotates towards the exposure opening and presses on the first buffer assembly to be slow movements thereof.

13. The foot-operated flip-top trash can according to claim 8, wherein the box member comprises a box body and a cover body, the box body is mounted on the main cover, any one of the box body and the cover body form a ventilation hole, the placement space is formed in the box body, and the box body further has a placement opening communicated with the placement space, a size of the placement opening is adapted to a size of the cover body, the placement opening is for placing the filter into the placement space, and the cover body is mounted on the box body so as to open or close the placement opening.

14. The foot-operated flip-top trash can according to claim 9, wherein the deodorizing box further comprises a start-end date display member comprising a date identifier rotatably mounted on the box member, twelve month-identifiers are arranged and equally spaced on a surface of date identifier with an axis of the date identifier being a center thereof, and a start-end date display assembly comprising a start-date display structure and an end-date display structure both provided on the box member, the date identifier is rotatable, so that any one of the month-identifiers on the surface is corresponding to the end-date display structure, and in case where one of the month-identifier on the date identifier is corresponding to the start-date display structure, another one of the month-identifier spaced with a predetermined distance with the month-identifier is corresponding to the end-date display structure, the number of months between the months represented by the two month-identifiers is consistent with an expiration period of the filter.

15. The foot-operated flip-top trash can according to claim 2, wherein the foot-operated flip-top trash can further comprises a deodorizing box, the deodorizing box comprises a box member, the box member is mounted on the main cover and rotate together with the main cover, the box member has a placement space and a plurality of ventilation holes communicated with the placement space, the placement space is for placing a filter, and in case where the covering-closing assembly seals the exposure opening, the box member is placed in the receiving cavity.

16. The foot-operated flip-top trash can according to claim 3, wherein the foot-operated flip-top trash can further comprises a deodorizing box, the deodorizing box comprises a box member, the box member is mounted on the main cover and rotate together with the main cover, the box member has a placement space and a plurality of ventilation holes communicated with the placement space, the placement space is for placing a filter, and in case where the covering-closing assembly seals the exposure opening, the box member is placed in the receiving cavity.

17. The foot-operated flip-top trash can according to claim 4, wherein the foot-operated flip-top trash can further comprises a deodorizing box, the deodorizing box comprises a box member, the box member is mounted on the main cover and rotate together with the main cover, the box member has a placement space and a plurality of ventilation holes communicated with the placement space, the placement space is for placing a filter, and in case where the covering-closing assembly seals the exposure opening, the box member is placed in the receiving cavity.

18. The foot-operated flip-top trash can according to claim 5, wherein the foot-operated flip-top trash can further comprises a deodorizing box, the deodorizing box comprises a box member, the box member is mounted on the main cover and rotate together with the main cover, the box member has a placement space and a plurality of ventilation holes communicated with the placement space, the placement space is for placing a filter, and in case where the covering-closing assembly seals the exposure opening, the box member is placed in the receiving cavity.

19. The foot-operated flip-top trash can according to claim 6, wherein the foot-operated flip-top trash can further comprises a deodorizing box, the deodorizing box comprises a box member, the box member is mounted on the main cover and rotate together with the main cover, the box member has a placement space and a plurality of ventilation holes communicated with the placement space, the placement space is for placing a filter, and in case where the covering-closing assembly seals the exposure opening, the box member is placed in the receiving cavity.

20. The foot-operated flip-top trash can according to claim 7, wherein the foot-operated flip-top trash can further comprises a deodorizing box, the deodorizing box comprises a box member, the box member is mounted on the main cover and rotate together with the main cover, the box member has a placement space and a plurality of ventilation holes communicated with the placement space, the placement space is for placing a filter, and in case where the covering-closing assembly seals the exposure opening, the box member is placed in the receiving cavity.
